(19) United States
(12) Patent Application Publication
(10) Pub. No.: US 2005/0098982 A1
(43) Pub. Date: May 12, 2005

(54) Stroller frame

(75) Inventor: Pao-Shan Huang, Chia-I Hsien (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 10/984,924

(22) Filed: Nov. 10, 2004

(30) Foreign Application Priority Data
Nov. 12, 2003 (TW) 92220057

(51) Int. Cl. B62B 7/08

(52) U.S. Cl. 280/642

(57) ABSTRACT

A stroller frame includes a first joint assembly and a second joint assembly. For folding the frame, release the first joint assembly to turn the tubular members and the second joint assembly in the folding direction until reaching a selected angle in which the frame is prevented by the second joint assembly from continuously folding. This prevents incidental collapsing of the frame caused by improper operation of users or malfunction of the first joint assembly, which could result in injury. By releasing the second joint assembly, the frame may be folded continuously until fully collapsed.

### FIELD OF THE INVENTION

The invention relates to a stroller frame that has a first joint assembly and a second joint assembly to enable the frame to be folded in two stages to prevent the frame from collapsing accidentally.

### BACKGROUND OF THE INVENTION

Conventional strollers, playpens or serving tables and chairs for children usually have a frame structure consisting of a plurality of tubular members. Referring to FIG. 1, taking a stroller 7 for example, there is a frame consisting of a plurality of tubular members 71, 72, 73 pivotally coupled with one another. The frame is coupled with a fabric padding to form a space for seating a baby. The frame is also pivotally coupled with wheels 8 for moving. These products consisting of tubular members 71, 72, 73 have a common design feature, namely the tubular members 71, 72, 73 are collapsible to a smaller size to save storage space when not in use. Hence the tubular members 71, 72, 73 are movable relative to one another. To ensure that the tubular members 71, 72, 73 are anchored properly in a use condition, a latch structure is deployed between two tubular members 71 and 72, 71 and 73, 72 and 73. The latch structure has to be released when folding the tubular members 71, 72, 73.

For instance, U.S. Pat. No. 6,464,242 discloses a stroller with a release mechanism on the handgrip for releasing the joint assembly. To prevent users from folding the frame mistakenly, a locking mechanism is provided on the release mechanism. Users have to unlatch the locking mechanism before activating the release mechanism. As the locking mechanism and the release mechanism are located on the same position, a user can single-handedly fold the frame. But with users who are not familiar with the operation procedures, incidental collapsing or improper folding of the frame might occur.

### SUMMARY OF THE INVENTION

In view of the aforesaid concerns, the primary object of the invention is to provide a stroller frame that has a second joint assembly to provide a two-stage safety constraint during folding so that the frame may be prevented from collapsing accidentally.

Another object of the invention is to provide a second joint assembly that is integrated with the frame and has a release position located differently to facilitate user recognition during operation.

The stroller frame according to the invention includes a handle bracket coupling with a front bracket, a rear bracket pivotally coupling with the handle bracket, and a seat rack pivotally connecting the front bracket and the rear bracket. The handle bracket and the front bracket are connected by a first joint assembly to allow the frame to be latched in an extended condition and released for folding. To fold the frame, release the first joint assembly to make the tubular members turnable relative to one another. When the tubular members are turned to a selected angle, the second joint assembly forms a latch constraint to prevent the tubular members from turning further in the folding direction. The second joint assembly has to be released to finish folding the frame. Hence the second joint assembly can prevent the frame from collapsing accidentally to enhance safety.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional stroller frame in an extended condition.

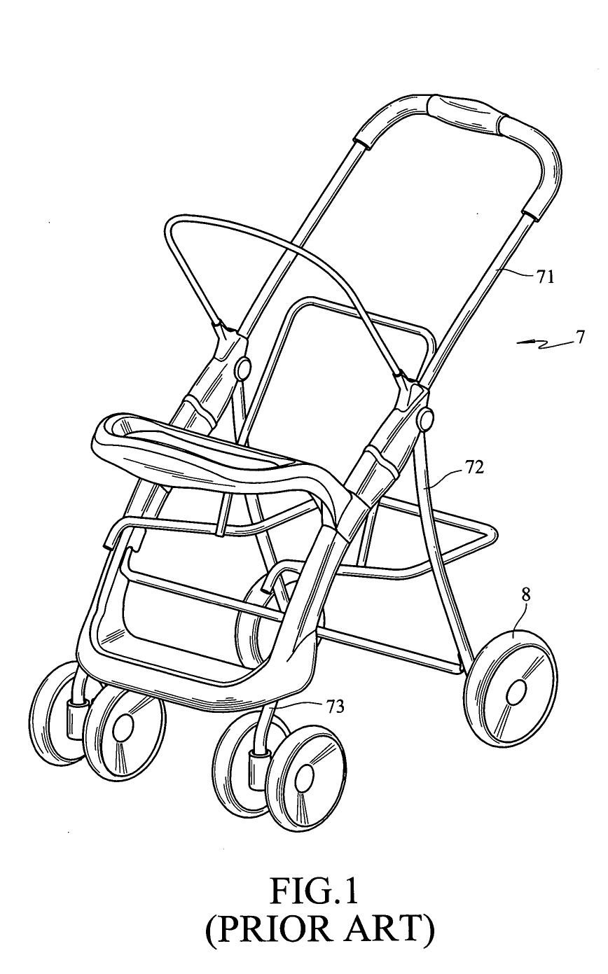

FIG. 2 is a schematic view of the stroller frame of the invention in an extended condition.

FIG. 3 is a top view of the linkage plate and the driving plate of the invention in an extended condition.

FIG. 4 is a schematic view of the second joint assembly in a folding condition.

FIG. 5 is a schematic view of the stroller frame of the invention in a collapsed condition.

### DESCRIPTION OF THE PREFERRED EMBODIMENT

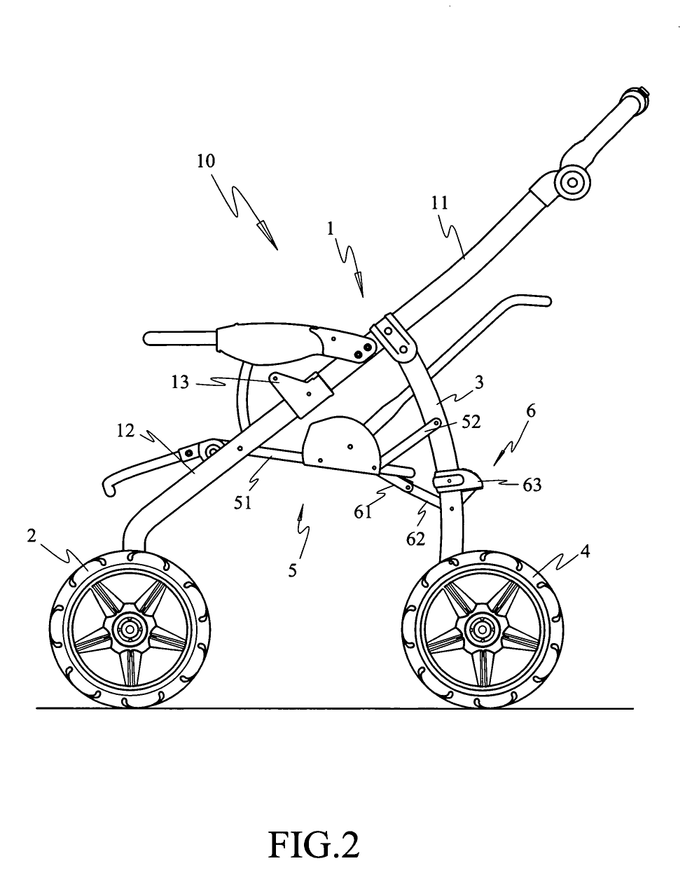

Referring to FIG. 2, the stroller frame 10 according to the invention aims to provide a two-stage folding function to prevent incidental collapsing and danger. The frame 10 includes a front bracket assembly 1, a rear bracket 3, a seat rack 5 and a second joint assembly 6.

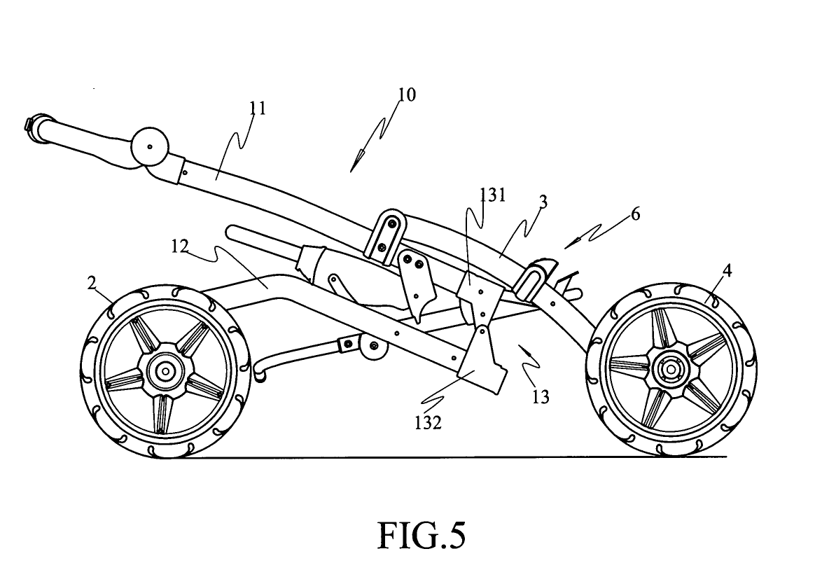

Referring to FIG. 5, the front bracket assembly 1 includes a handle bracket 11, a front bracket 12 and a first joint assembly 13 for latching and releasing. The first joint assembly 13 includes an upper joint 131 and a lower joint 132. In the invention, the first joint assembly 13 adopts a conventional structure, which has a locking mechanism to perform latching or releasing operation, such as U.S. Pat. No. 5,460,398 or R.O.C. publication No. 248148. The first joint assembly 13 connects the handle bracket 11 and the front bracket 12 to control latching and releasing of the two brackets. The front bracket 12 has a lower end coupled with a front wheel assembly 2.

The rear bracket 3 has an upper end pivotally coupled with the front bracket assembly 1 and a lower end coupled with a rear wheel assembly 4, which cooperates with the front wheel assembly 2 to support the frame 10. In this embodiment, the rear bracket 3 is pivotally coupled with the handle bracket 11, but may also be pivotally coupled with the first joint assembly 13 depending on the size of the frame.

The seat rack 5 includes a front seat bar 51 and a rear seat bar 52 that pivotally connect the front bracket 12 and the rear bracket 3 to extend or fold the front bracket 12 and the rear bracket 3.

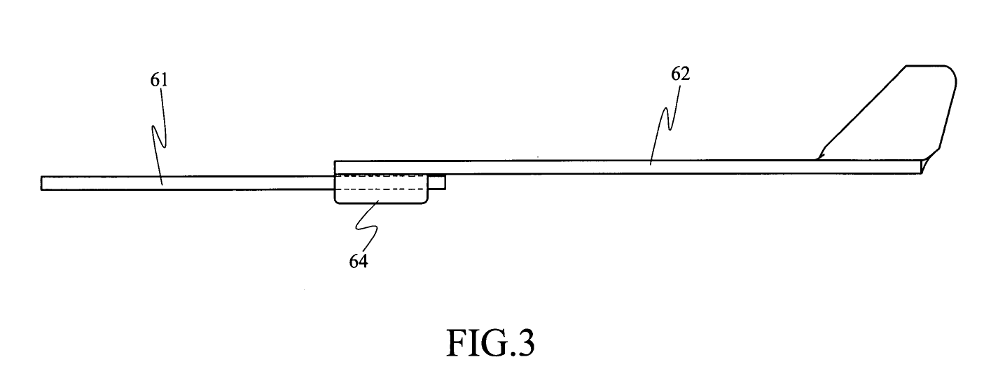

The second joint assembly 6 connects the seat rack 5 and the rear bracket 3, and includes a linkage plate 61, a driving plate 62 and a release member 63. The linkage plate 61 is pivotally coupled with the driving plate 62, which has a latch section 64 (referring to FIG. 3). The linkage plate 61 and the driving plate 62 pivotally connect the seat rack 5 and the rear bracket 3. The release member 63 is coupled on another end of the driving plate 62 and can slide on the rear bracket 3.

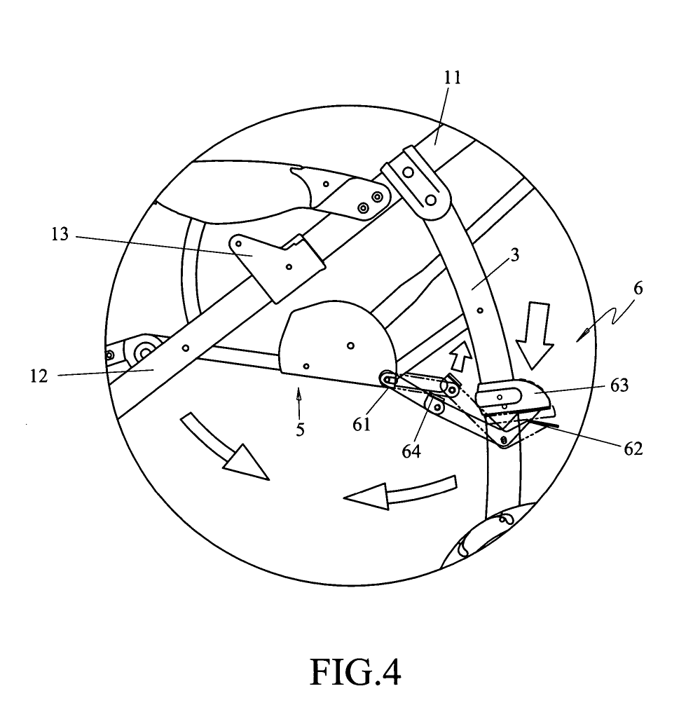

Referring to FIG. 4, by means of the construction set forth above, after the first joint 13 is released, the tubular members of the frame 10 may be turned in the folding direction. As the second joint assembly 6 is a part of the frame 10, it also turns with the frame 10 until the frame reaches a selected angle. Due to alterations of the linear distance between the pivotal points, the linkage plate 61 and the driving plate 62 of the second joint assembly 6 are turned and folded in the opposite direction, moved downwards, stopped and latched by the latch section 64, and form a turning dead point of the frame 10. Hence the tubular members of the frame 10 cannot be turned and folded further. To continue folding, turn the driving plate 62 through the release member 63 to move the linkage plate 61 and the driving plate 62 in the reverse direction to form an inverse V shape so that the linkage plate 61 and the driving plate 62 are turned in the same direction as the folding direction of the frame 10. The frame 10 may then be folded continuously until fully collapsed (referring to FIG. 5). The two-stage folding of the frame described above can enhance safety.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A stroller frame, comprising:
a front bracket assembly, including a handle bracket, a front bracket and a first joint assembly connecting the handle bracket and the front bracket for controlling extending and folding of the front bracket assembly;
a rear rack, having one end pivotally coupled with the front bracket assembly;
a seat rack, pivotally connecting the front bracket assembly and the rear rack; and
a second joint assembly, pivotally connecting the seat rack and the rear bracket to constrain turning of the seat rack relative to the rear bracket;
wherein the front bracket assembly, the rear bracket and the seat rack form a steady latched condition through latching of the first joint assembly and the second joint assembly.

2. The stroller frame of claim 1, wherein the second joint assembly includes a linkage plate, a driving plate, a release member, and a latch section, and the linkage plate being pivotally coupled with the driving plate, and the latch section preventing the linkage plate and the driving plate from turning continuously.

3. The stroller frame of claim 2, wherein the linkage plate has one end pivotally coupled with the seat rack, and the driving plate having one end pivotally coupled with the rear bracket.

4. The stroller frame of claim 2, wherein the latch section is integrally extended from the driving plate.

5. The stroller frame of claim 2, wherein the release member is coupled on the rear bracket in a slidable manner to move and turn the driving plate to release latching between the linkage plate and the driving plate, and to allow the frame to be folded continuously.

6. The stroller frame of claim 1, wherein the seat rack includes a front seat bar and a rear seat bar to pivotally connect the seat rack with the front bracket and the rear bracket respectively to extend or fold the front bracket and the rear bracket.

7. The stroller frame of claim 1, wherein the front bracket assembly and the rear bracket have respectively a lower end to couple with a front wheel assembly and a rear wheel assembly to hold the frame.
